(19) United States
(12) Patent Application Publication
(10) Pub. No.: US 2008/0177894 A1
(43) Pub. Date: Jul. 24, 2008

(54) Methods and Apparatus For Improving Interactions Between Multi-Server Web Environments and Web Browsers

(76) Inventors: Raymond B. Jennings, Ossining, NY (US); Anees Shaikh, Yorktown Heights, NY (US); David A. George, Somers, NY (US)

Correspondence Address: Harrington & Smith, PC, 4 Research Drive, Shelton, CT, 06484-6212, US

(21) Appl. No.: 11/625,384

(22) Filed: Jan. 22, 2007

(51) Int. Cl. G06F 15/16

(52) U.S. Cl. 709/232

(57) ABSTRACT

Disclosed herein are methods and apparatus that improve the perceived responsiveness of a multi-server web site or web environment to web requests issued by web browsers. In one aspect, the methods and apparatus operate by determining a likely sequence of web pages to be accessed by users. The methods and apparatus then incorporate information identifying web pages and web page content likely to be requested later in the sequence in web pages responsive to web page requests received earlier in the sequence. In one such method, the URL of a second web is incorporated in a first web page that is expected to be requested before the second web page. A web client receiving the first web page will then issue a DNS request for address information corresponding to the URL of the second web page even if no request has been received for the second web page. Thus, the probability of a DNS system cache miss occurring when a web request for the second web page is actually received by the web client is significantly reduced.

### TECHNICAL FIELD

The present invention generally concerns methods and apparatus for use in multi-server web sites and web browsers and more specifically concerns methods and apparatus that improve the perceived responsiveness of multi-server web sites and web environments.

### BACKGROUND

Users seeking content (such as, for example, web pages) from a web site often are confronted by delays. The sought web page may take tens of seconds to load, even if the user has a high-speed connection. The situation may not improve with each successive web page requested from the web site. Each successive web page may similarly load slowly. The perceived lack of responsiveness of the web site may be a source of dissatisfaction for a user. In fact, it might lead the user to conclude that the web site is poorly designed and managed. In view of such a conclusion, the user may seek another web site providing the same information or service.

What users may not understand is the perceived lack of responsiveness of the web site may not be the fault of the web site itself but may actually be caused by other elements of the web that are separate from the web site. For example, servers associated with the Domain Name System (hereinafter “DNS”) of the web often are consulted to service a request for web content. These servers are not part of the web site providing the content, but often provide address information needed to properly address requests to the web site for content. Delays in the DNS system in providing the address information may be mistakenly be attributed to the web site.

In more detail, DNS servers typically have associated address caches where address information for recently visited web sites is stored. For example, when a web client issues a request for a web page maintained by a web site that has not been recently visited, the web client will issue a DNS request to the DNS system for the address information. Depending upon the DNS server used by the client, the DNS request resolution time can vary. For DNS servers that serve a large number of clients, the address for the web site may already be in the cache of a local DNS server. In such a situation, the DNS system simply provides the address information to the web client from the cache of the local DNS server. For a DNS server that services a small number of clients, the server typically will not have the DNS entry within its local cache, resulting in a so-called “DNS cache miss”. When a DNS cache miss occurs, the local DNS server used by the client must make requests to additional DNS servers. These additional DNS requests can result in a long wait period for the web client.

This problem is increased when a web client visits a page that consists of many URLs that each have different hostnames, even if the hostnames are within the same network domain. Each different hostname requires a DNS request and response. If there is a DNS delay, this can give the user the false impression that the web site is at fault when in fact it is the DNS system that is causing the delay.

Similar problems may be encountered when a web page is produced using multiple content elements stored on web servers having different hostnames. If there is a delay in receiving any of the content elements, depending on the browser used, either the entire web page may be delayed in rendering, or the web page may be only partially rendered leaving blanks where content (such as, for example, images; text; dynamic elements) should appear.

Thus, those skilled in the art seek improvements for use in multi-server web sites and web environments that improve the perceived responsiveness of the web sites and web environments to users. In particular, those skilled in the art seek improvements that reduce the likelihood that delays occurring in the DNS system will actually be perceived by a user. DNS cache misses and resulting DNS delays may still occur, but those skilled in the art seek improvements that mask the delays from the user so that the user does not realize that delays are occurring.

### SUMMARY OF THE INVENTION

The foregoing and other problems are overcome, and other advantages are realized, in accordance with the following embodiments of the invention.

A first embodiment of the invention is a method. In the method, movement from a first web page to a second web page is identified as an expected transition. It is assumed that the first web page is stored on a first server having a first hostname, and the second web page is stored on a second server having a second hostname different from the first hostname. Then, identification information is selected for the second web page that can be used to issue a DNS request for address information needed to service a web request for the second web page. Next, the first web page is associated with identification information for the second web page. Then, the association of the first web page with identification information for the second web page is saved to computer memory.

A second embodiment of the invention is a method occurring in a multi-server web environment. In the second method, a first web request is received from a web client for web content. Then, a response to the first web request is generated, wherein the response comprises the web content sought by the first web request and additional information. The additional information can be used by the web client to issue at least one DNS request for address information that will be needed to service an anticipated second web request. It is expected that the web client will issue the anticipated second web request after the first web request. Next, the response containing the web content sought by the first web request and the additional information is transmitted to the web client.

A third embodiment of the invention is a computer program product comprising a signal bearing medium tangibly embodying a computer readable program executable by digital processing apparatus. The computer readable program, when executed by digital processing apparatus, is configured to receive a first web request from a web client for a first web page; to generate a response to the first web request, wherein the response comprises the web page sought by the first web request and content element identification information identifying additional web content that will be needed to reproduce a second web page; and to transmit the response to the web client.

A fourth embodiment of the invention is a system comprising: a web site incorporating a plurality of web servers, at least first and second web servers of the plurality having URLs with hostnames different from one another; a computer memory coupled to the web site, the computer memory storing a computer program configured to perform operations for managing the web site when executed by digital processing apparatus; and a digital processing apparatus coupled to the web site and the computer memory, the digital processing apparatus configured to execute the computer program. Each of the first and second web servers with hostnames different from one another provides content used to produce a particular web page. When the computer program is executed by the digital processing apparatus, the system is configured to identity that the particular web page is produced using content provided by the first and second servers, wherein the first and second servers have different hostnames; to change the hostname associated with content used in the particular web page provided by the second web server to the hostname of the first web server; and to copy the content with the changed hostname to the first web server.

In conclusion, the foregoing summary of the various embodiments of the present invention is exemplary and non-limiting. For example, one or ordinary skill in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Invention, when read in conjunction with the attached Drawing Figures, wherein:

FIG. 1 is a block diagram depicting a multi-server web environment in which methods and apparatus of the invention may be practiced;

FIG. 2 is a flowchart depicting a method operating in accordance with the invention;

FIG. 3 is a flowchart depicting a method operating in accordance with the invention;

FIG. 4 is a flowchart depicting a method operating in accordance with the invention; and

FIG. 5 is flowchart depicting a method operating in accordance with the invention.

### DETAILED DESCRIPTION OF THE INVENTION

One embodiment of the invention is practiced in a situation when a web client issues a request for a series of web pages. Ordinarily, before any web page request can be issued the web client must first obtain the DNS entry for the web page server (the IP address of the web server) that contains the web page. Methods and apparatus of this invention anticipate this by including URLs for web pages likely to be requested later in a series of requests for web pages in web pages responsive to initial requests. When the contents of the initial web pages are delivered to the web client, the web pages contain embedded URLs that consist of other hostnames within the website that the web client will likely visit. By including URLs in the first or initial web pages that contains the hostnames that the web client will likely need in order to make further requests for subsequent web pages, the web client can get a head start on resolving hostnames. This process will allow the web client to skip the DNS request/response steps when a subsequent web page is requested from one of the other web servers because the web client will already have saved the DNS entry within its local DNS cache. The included URLs are encoded as “hidden” images or other web objects which allow the initial page to be rendered without having to wait for the hidden images or objects to be downloaded from the site. These hidden images could be one pixel images that appear at the end of the page or off-screen from the page.

By including the hidden images within a web page, this forces any web client to pre-fetch DNS entries which the web client will likely need for a subsequent HTTP request.

In one embodiment, the present invention is a method and apparatus for providing information to a web client so that the web client can pre-resolve DNS entries. Embodiments of the present invention also allow website creators to normalize the network load over a series of web pages by copying embedded URLs contained within the pages. Embodiments of the invention further allow creators of websites to minimize the number of TCP connections that a client must use in order to view a particular web page.

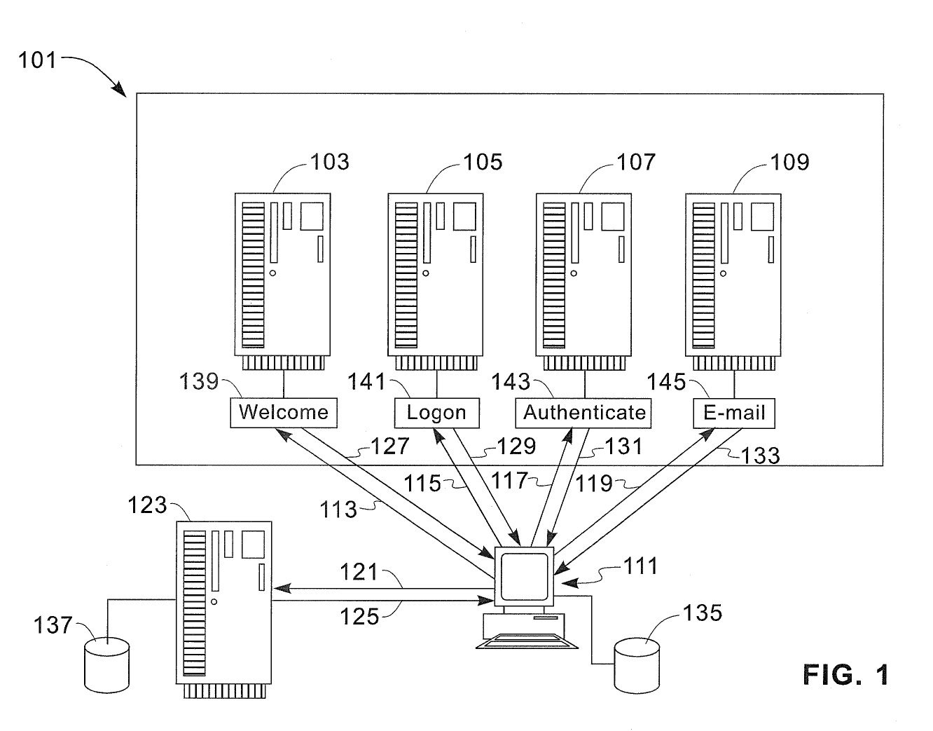

FIG. 1 depicts a typical network environment showing a website 101 consisting of multiple web servers 103, 105, 107 and 109. A web client 111 will make a series of HTTP requests 113, 115, 117 and 119 to the website 101. Before each one of the web requests 113, 115, 117 and 119 is made to the corresponding web server 103, 105, 107 and 109 a DNS request 121 is made by the web client 111 to a local DNS server 123. The DNS server 123 may make additional DNS requests to other DNS servers (not shown) in order to satisfy the DNS request 121. When the DNS server issues a reply 125 to the web client 111 the web client 111 can then send the HTTP request 113 to the web server 103 and the web server 103 will reply 127 back to the web client 111 with the contents of the web page 139. The same process occurs for the other web servers, HTTP requests and web pages.

The web site 101 consists of four web servers 103, 105, 107 and 109 that may have the same Internet domain name but may each have a different hostname.

If the local DNS server 123 does not have the address entry for each of the web servers 103, 105, 107, 109 when the web client 111 makes each of the DNS requests 121 there can be a delay as the DNS server 123 obtains the address for the web client 111. The delay can occur for each request for each web server within the web site. This delay is not the fault of the website 101 but rather the DNS server that the web client 111 is using.

In order to improve a user's experience of the website 101 the author of the website 101 can make improvements in accordance with the invention to speed up the resolution of DNS names.

The first step is to create a set of possible transitions from one web page to another. A transition occurs between a pair of web pages where an initial web page of the pair is web page that a user would be expected to view first and the later page is a web page that the user would be expected to view after the user has viewed the initial web page. For web site 101 this would result in a transition set of: (Welcome 139 to Logon 141), (Logon 141 to Authenticate 143), (Authenticate 143 to E-mail 145). Depending on implementation, the transition set can consist of all possible transitions or just the most popular. “Most popular” can be manually chosen or determined from past history of the web site 101.

Using the set of web page transitions, URLs can be added to each web page, where the URLs refer to a future page, or to a future series of web pages. The embedded URLs can be a “hidden” image file that appears out of the normal view of the user. By using a hidden image it will allow the web page to render on the screen while the DNS request 121 and the response 125 are taking place for the hostname that contains the hidden image. There is typically some “think time” when a page is rendered on a screen when the user must view the page. During this think time the DNS request 121 and the response 125 can occur making the user unaware of the delay.

Referring to FIG. 1, a hidden image is included within the Welcome page 139 on the web server 103 that refers to web server 105. When the user clicks on a URL from within the Welcome page 139 to request the contents of the Logon page 141, the web client 111 will already have the DNS entry due to the hidden image that forced the web client 111 to “pre-resolve” the hostname for web server 105. In this example, web page 141 on web server 105 is the most likely request to follow after the web page 139 on web server 103.

In other embodiments, URLs for multiple web pages in a sequence can be included in a web page likely to be requested first. In the example of FIG. 1, this can be accomplished by including hidden image URLs for websites 107 and 109 within the Welcome page 139 as well.

The hidden image can be something such as a 1 pixel image or an image that appears off the screen or out of view of the user. In addition other objects could be used instead of an image URL such as a script file. Anything that causes the web client 111 to make a DNS request for the desired hostname could be used.

In alternate embodiments, actual physical address information may be provided. This can be done when it is known that the address of an item is unlikely to change. This totally eliminates in certain circumstances the need for a DNS query. Since addresses for many items can be expected to change, though, it is better in other instances to provide identification information (URLs) so the DNS system can be queried for an up-to-date address.

In addition, the web site creator can use the identified set of web page transitions to normalize the network load over the set of web servers 103, 105, 107, 109 within website 101. This process would occur by moving content that appears on subsequent web pages to previous pages. For example, if an image file is shown on the logon page 141 on web server 105 then a hidden URL can be placed on the welcome page 139 for the web server 103. Doing this results in a web client 111 pre-fetching the image for the logon page 141 before the actual logon page 141 is requested by the web client 111. This image when requested as part of the Welcome page 139 would be hidden from the user. When the HTTP request 115 is made for the Logon page, the web client 111 will already have the image within its cache and will not have to request the image in order to render the Logon page 141.

In a variation of this embodiment where security is a concern, providing content in anticipation of future need can be selectively disabled either by the web site or web client. For example, the web client can signal the web site that address information or content should not be provided in anticipation of future need.

A third improvement provided by embodiments of the invention is obtained by reducing the number of TCP connections needed to render a web page. The number of TCP connections is equal to the number of unique hostnames found within all of the URLs of a web page. Using this technique, if an image file URL within the Welcome page 139 on web server 103 is located on another web server (105, 107, 109) within the web site 101 then that image could be copied from the other web server to web server 103. This process would allow a web client 111 to render a web page with only one TCP connection using multiple HTTP requests over the same TCP connection (Known as HTTP 1.1)

The three improvements just described can be automated by including the methods within a web site authoring application.

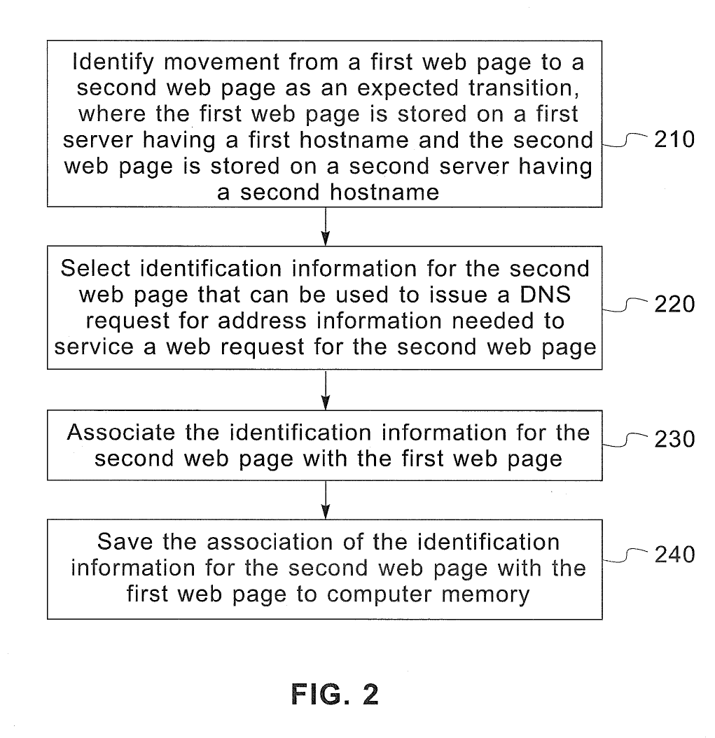

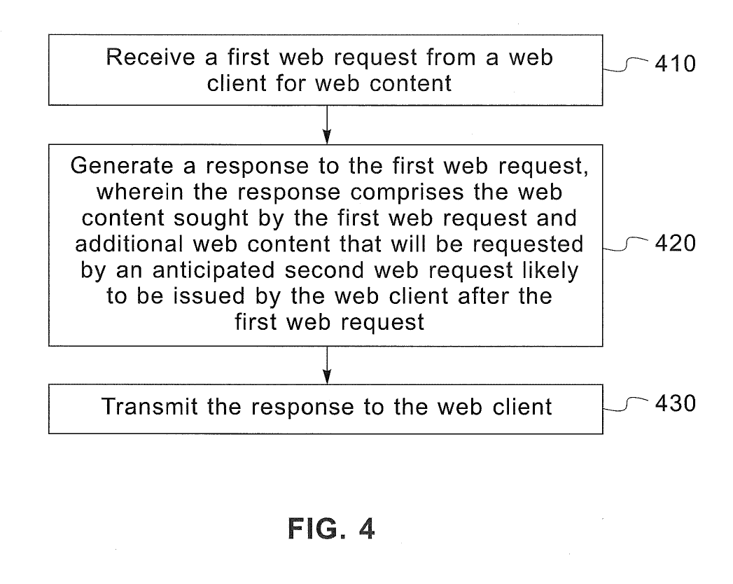

In summary, FIGS. 2-5 depict methods operating in accordance with the invention that can be practiced alone or in combination. In the method depicted in FIG. 4, at step 210 web pages accessible from different web servers of a web site like that depicted in FIG. 1 are analyzed to identify likely web page sequences. A “web page sequence” is a series of web pages likely to be serially accessed by a user, such as the sequence comprising the welcome web page 139; logon web page 141; authenticate web page 143; and e-mail web page 145 depicted in FIG. 1. In step 210, as an example, a movement from a first web page to a second web page is identified as an expected transition. It is assumed that the first web page is stored on a first server having a first hostname and the second web page is stored on a second server having a second hostname, wherein the second hostname of the second server is different from the first hostname of the first server. Then, at step 220, identification information is selected for the second web page that can be used to issue a DNS request for address information needed to service a web request for the second web page. Next, at step 230, identification information for the second web page is associated with the first web page in some manner such as, for example, by creating a data entry memorializing the association. Then, at step 240, the association of the identification information for the second web page with the first web page is saved to computer memory.

In one variant of the embodiment depicted in FIG. 2, associating the identification information for the second web page with the first web page further comprises incorporating the identification information for the second web page in the first web page and saving the association of the identification information further comprises saving the first web page in a form incorporating the identification information for the second web page.

Typically, the identification information for the second web page comprises a URL. Further, in typical embodiments, the URL comprising the identification information for the second web page is hidden so that when the first web page is displayed the URL for the second web page is not visible.

In another variant of the method depicted in FIG. 4 additional steps are performed at the first web server of the web site. In the additional steps, the first web server receives a first web request for the first web page from a web client; and the first web server transmits the first web page, wherein the first web page incorporates the identification information for the second web page. In one typical example of this variant the first web request comprises an HTTP request.

In a further variant of the method depicted in FIG. 4 additional steps are performed at the web client. In this variant, the web client receives the first web page; recovers the identification information (such as, for example, a URL) for the second web page from the first web page; and prior to receiving a request for the second web page, the web client issues a DNS request for address information using the identification information for the second web page recovered from the first web page. In contrast to the prior art, the ability to issue a DNS request for address information needed to service a request for the second web page before such a request is actually received often avoids delays typically attributed to a web site but which are, in fact, caused by DNS cache system misses.

Yet another variant of the method depicted in FIG. 4 can be practiced in combination with the steps of the method of FIG. 4 or alone. The preceding steps sought to eliminate delays associated with requesting address information needed to service a request for a web page from the DNS system. The following steps seek to eliminate delays associated with requesting content elements needed to reproduce a web page by requesting the content elements before a request for the web page is received. In this variant the following additional steps are performed: after identifying movement from the first web page to the second web page as an expected transition, at least one content element needed to reproduce the second web page is identified; and content element identification information (such as, for example, a URL) identifying the at least one content element needed to reproduce the second web page is added to the first web page. Performing the steps of this variant is done to normalize traffic between the web and servers of the web site by causing web clients to request content stored on the second server needed to reproduce the second web page before the web client issues a request for the second web page.

In a still further variant, the first web server receives a first web request for the first web page from a web client; and the first web server transmits the web page in response to the web request. As indicated previously, the first web page has been amended to incorporate content element identification information identifying a content element needed to reproduce a second web page. Accordingly, upon receipt of the first web page, the web client treats the URLs in the first web page (including the URL corresponding to the content element needed to reproduce the second web page) like any other URL and requests the content corresponding to the URLs. In this manner, the web client issues a request for the content element needed to reproduce the second web page before the web client receives a request for the second web page from the user.

In another variant of the method depicted in FIG. 4 steps can be taken at the web site depicted in FIG. 1 to reduce the number of TCP connections needed to reproduce a web page resident on one of the web servers of the web site. In this variant additional steps are performed, the steps comprising: identifying that the first web page is produced using content provided by the first and second servers; changing the hostname associated with the content used to produce the first web page provided by the second server to the hostname of the first server; and copying the content with the changed hostname originally provided by the second server to the first server. As indicated, these steps are performed to reduce the number of TCP connections need to produce a web page.

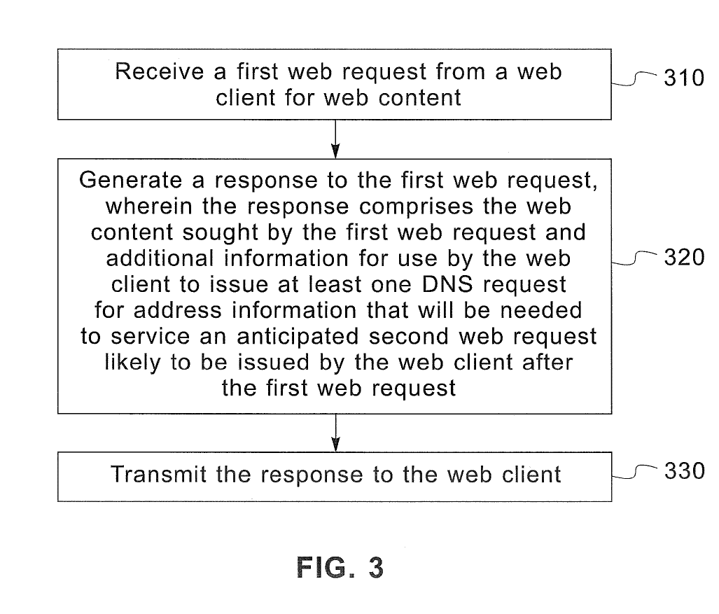

Another embodiment of the aspect of the invention that provides identification information that can be used to issue a DNS request for address information needed to service a web request for a web page before the web request is actually received is depicted in FIG. 3. In contrast to the method depicted in FIG. 2 the steps of which are performed typically during the construction of the web site, the steps of FIG. 3 can also be performed on the fly as web requests are received. In the method of FIG. 3 at step 310 a web site comprising a plurality of web servers receives a first web request from a web client for web content. Then, at step 320, a response is generated to the first web request, wherein the response comprises the web content sought by the first web request and additional information for use by the web client to issue at least one DNS request for address information that will be needed to service an anticipated second web request likely to be issued by the web client after the first web request. Next, at step 230, the response is transmitted to the web client.

In a variant of the method depicted in FIG. 3 further steps are performed at the web client. In a first further step, the web client recovers the additional information from the response. In a second further step that occurs prior to receipt of the anticipated second web request, the web client uses the additional information to issue at least one DNS request for address information that will be needed to service the anticipated second web request when it is received.

As indicated, the method depicted in FIG. 3 can operate on the fly or in a predetermined fashion. In a variant of the method depicted in FIG. 3 operating in a predetermined fashion, additional steps are performed prior to receipt of the first web request. The additional steps comprise: identifying movement from the first web page to the second web page as an expected transition; selecting the additional information that can be used to issue a DNS request for address information needed to service the anticipated second request; and saving the additional information to a computer memory.

In another variant of the method depicted in FIG. 3 operating in a predetermined fashion, additional steps are performed to identify a plurality of transitions. In this variant the following additional steps are performed: identifying a plurality of expected transitions from initial web pages to later web pages, wherein different hostnames are used within URLs associated with the initial web page and later web page of each transition pair; selecting additional information that can be used to issue a DNS request for address information needed to service web requests seeking the later web pages; and saving the additional information to computer memory.

FIG. 4 depicts another method similar to a foregoing variant described with respect to FIG. 2. In the method, it is determined that a second web request seeking a second web page is typically issued after a first web request seeking a first web page. It is also true that the first web page and associated content is stored on a first server with a first hostname and that the second web page and associated content is stored on a second server with a second hostname different from the first hostname. As described previously, in certain circumstances it is desirable to normalize traffic between the web client and the first and second servers by causing the web client to request content elements needed to reproduce a web page before the web client receives a request for the web page when it is known that a request for the web page will likely follow a request for an earlier web page.

In the method of FIG. 4, at step 410 the first web server receives a first web request from a web client for a first web page. Then, at step 420, the web client generates a response to the first web request, wherein the response comprises the web page sought by the first web request and content element identification information identifying a content element needed to reproduce a second web page. Then, at step 430, the first web server transmits the response to the web client.

In a variant of the method depicted in FIG. 4 additional steps are performed at the web client. In the additional steps the web client receives the response comprising the first web page and the content element identification information identifying a content element needed to reproduce a second web page; recovers the content element identification information from the response; and issues a web request for the content element needed to reproduce the second web page.

In another variant of the method depicted in FIG. 4, the content element identification information comprises a URL that is added to the first web page in such a manner that neither the URL nor the content corresponding to the URL is visible to a user when the user views the web page. Nonetheless, the incorporation of a URL corresponding to a content element needed to reproduce a second web page in the first web page causes the web client to issue a request for the content element before a request for the second web page is received.

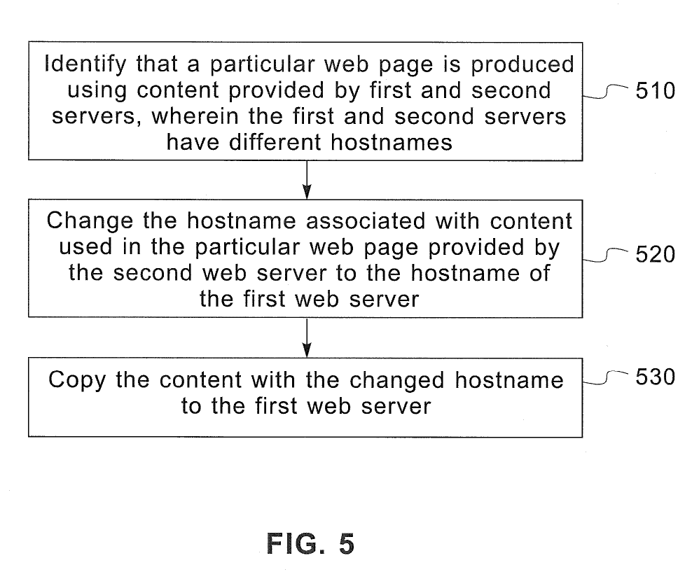

FIG. 5 depicts another embodiment of the invention somewhat similar to a variant described with respect to FIG. 2. The embodiment depicted in FIG. 5 corresponds to a method that seeks to reduce the number of TCP connections needed to reproduce a web page. As described previously, it is not unusual for a web page to include content elements that are stored in different servers having different hostnames. In such a situation, it is necessary to establish a TCP connection with each server having a different hostname in order to recover the content necessary to reproduce accurately the web page. It is desirable to reduce or even minimize the number of TCP connections required to reproduce a web page, and the method in FIG. 5 accomplishes this end.

At step 510 of the method, it is identified that a particular web page is produced using content provided by first and second servers, wherein the first and second servers have different hostnames. Then, at step 520, the hostname associated with the content used in the particular web page provided by the second web server is changed to the hostname of the first web server. Next, at step 530, the content with the changed hostname originally stored in the second web server is copied to the first web server. These operations reduce the number of TCP connections needed to reproduce the particular web page by one. If the content needed to produce the particular web page is only provided by the first and second web servers, the method depicted in FIG. 5 also minimizes the number of TCP connections needed to reproduce the web page.

One of ordinary skill in the art will understand that methods depicted and described herein can be embodied in a computer program storable in a tangible computer-readable memory medium or signal bearing medium. Instructions embodied in the tangible computer-readable memory or signal-bearing medium perform the steps of the methods when executed. Tangible computer-readable memory media include, but are not limited to, hard drives, CD- or DVD ROM, flash memory storage devices or in a RAM memory of a computer system.

In addition, apparatus associated with a web site such as the one depicted in FIG. 1 can be configured to perform operations corresponding to those depicted and described with respect to FIGS. 2-5. Such apparatus would comprise a computer readable memory storing a computer program configured to cause the apparatus to perform operations similar to those depicted in FIGS. 2-5 when executed and digital processing apparatus to perform the operations.

Thus it is seen that the foregoing description has provided by way of exemplary and non-limiting examples a full and informative description of the best apparatus and methods presently contemplated by the inventors for improving interactions between web sites comprised of servers having different hostnames and web clients. One skilled in the art will appreciate that the various embodiments described herein can be practiced individually; in combination with one or more other embodiments described herein; or in combination with web environments differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A method comprising:
identifying movement from a first web page to a second web page as an expected transition, where the first web page is stored on a first server having a first hostname and the second web page is stored on a second server having a second hostname, and wherein the second hostname is different from the first hostname;
selecting identification information for the second web page that can be used to issue a DNS request for address information needed to service a web request for the second web page;
associating the identification information for the second web page with the first web page; and
saving the association of the identification information for the second web page with the first web page to computer memory.

2. The method of claim 1 wherein associating the identification information for the second web page with the first web page further comprises incorporating the identification information for the second web page in the first web page and wherein saving the association of the identification information further comprises saving the first web page in a form incorporating the identification information for the second web page.

3. The method of claim 2 where the identification information for the second web page comprises a URL.

4. The method of claim 3 where the URL comprising the identification information for the second web page is hidden in the first web page so that when the first web page is displayed the URL for the second web page is not visible.

5. The method of claim 2 further comprising:
receiving a first web request for the first web page from a web client; and
transmitting the first web page to the web client, wherein the first web page incorporates the identification information for the second web page.

6. The method of claim 5 wherein the first web request is an HTTP request.

7. The method of claim 5 further comprising:
at the web client, receiving the first web page;
recovering the identification information for the second web page from the first web page; and
prior to receiving a web request for the second web page, issuing a DNS request for address information using the identification information for the second web page recovered from the first web page, wherein the address information provided in response to the DNS request can be used to service an anticipated second web request for the second web page likely to be received after the first web request.

8. The method of claim 1 further comprising:
after identifying movement from the first web page to the second web page as an expected transition, identifying at least one content element needed to reproduce the second web page; and
adding content element identification information identifying the at least one content element needed to reproduce the second web page to the first web page.

9. The method of claim 8 wherein adding the content element identification information identifying the at least one content element needed to reproduce the second web page to the first web page is done to normalize traffic between the web and the first and second servers by causing web clients to request content stored on the second server needed to reproduce the second web page before the web client issues a request for the second web page.

10. The method of claim 8 further comprising:
receiving a first web request for the first web page from a web client; and
transmitting the first web page in response to the web request, wherein the first web page incorporates content element identification information identifying the at least one content element needed to reproduce the second web page.

11. The method of claim 10 further comprising:
at the web client, receiving the first web page;
recovering the content element identification information identifying the at least one content element needed to reproduce the second web page from the first web page; and
issuing a web request for the at least one content element.

12. The method of claim 1 further comprising:
identifying that the first web page is produced using content provided by the first and second servers;
changing the hostname associated with the content used to produce the first web page provided by the second server to the hostname of the first server; and
copying the content with the changed hostname originally provided by the second server to the first server.

13. The method of claim 12 wherein the operations of changing the hostname and copying the content is done to reduce the number of TCP connections needed to reproduce the first web page.

14. A computer program product comprising a signal bearing medium tangibly embodying a computer readable program executable by digital processing apparatus, the computer readable program, when executed by digital processing apparatus, configured to receive a first web request from a web client for a first web page; to generate a response to the first web request, wherein the response comprises the web page sought by the first web request and content element identification information identifying additional web content that will be needed to reproduce a second web page; and to transmit the response to the web client.

15. The computer program product of claim 14 wherein the additional web content comprises at least one item selected from the group comprising: an image; a script; computer code; an applet that performs a dynamic operation.

16. The computer program product of claim 14 wherein the response further comprises web page identification information that can be used by the web client to issue at least one DNS request for address information that will be needed to service a second web request for the second web page likely to be issued by the web client after the first web request.

17. A system comprising:
a web site comprising a plurality of web servers, at least first and second web servers of the plurality of web servers having URLs with hostnames different from one another, wherein each of the first and second web servers with hostnames different from one another provide content used to produce a particular web page;
a computer memory coupled to the web site, the computer memory storing a computer program configured to perform operations for managing the web site when executed by digital processing apparatus; and
a digital processing apparatus coupled to the web site and the computer memory, the digital processing apparatus configured to execute the computer program, wherein when the computer program is executed, the system is configured to identity that the particular web page is produced using content provided by the first and second servers, wherein the first and second servers have different hostnames; to change the hostname associated with content used in the particular web page provided by the second web server to the hostname of the first web server; and to copy the content with the changed hostname to the first web server.

18. The system of claim 17 wherein the operations of changing the hostname associated with the content provided by the second web server to the hostname of the first web server and copying the content with the changed hostname to the first web server is done to reduce the number of TCP connections necessary to reproduce the particular web page.

19. The system of claim 17 where multiple web servers of the plurality of web servers have different hostnames, and wherein when the computer program is executed by the digital processing apparatus, the system is further configured to identify each of a plurality of web pages, where each of the plurality of web pages is produced using content provided by at least two different web servers having different hostnames; and for each of the identified web pages, to change a hostname associated with content provided by one of the two different web servers having different hostnames to the hostname associated with the other of the two different web servers; and to copy the content with the changed hostname to the other of the two different web servers.

20. The system of claim 17 wherein when the computer program is executed by the digital processing apparatus, the system is further configured to receive a first web request from a web client for web content; to generate a response to the first web request, wherein the response comprises the web content sought by the first web request and additional information for use by the web client to issue at least one DNS request for address information that will be needed to service an anticipated second web request likely to be issued by the web client after the first web request; and to transmit the response to the web client.
